(19) United States
(12) Patent Application Publication
(10) Pub. No.: US 2016/0266648 A1
(43) Pub. Date: Sep. 15, 2016

(54) SYSTEMS AND METHODS FOR INTERACTING WITH LARGE DISPLAYS USING SHADOWS

(71) Applicant: FUJI XEROX CO., LTD., Tokyo (JP)

(72) Inventors: Jun Shingu, Yokohama (JP); Akira Ichiboshi, Yokohama (JP); Patrick Chiu, Mountain View, CA (US); Sven Kratz, San Jose, CA (US)

(21) Appl. No.: 14/642,719

(22) Filed: Mar. 9, 2015

(51) Int. Cl. G06F 3/01; G06T 15/60

(52) U.S. Cl. CPC G06F 3/017; G06T 15/60

(57) ABSTRACT

A computer-implemented method being performed in a computerized system incorporating a processing unit, a memory, a display and a depth camera, the computer-implemented method involving: acquiring a depth image of a user using the depth camera; determining a spatial position of a point cloud corresponding to the user using the acquired depth image of the user; determining at least a portion of the point cloud corresponding to the user located within a virtual operation area; generating a virtual shadow of the user using the determined portion of the point cloud corresponding to the user located within the virtual operation area; displaying the generated virtual shadow of the user on the display; and using the displayed virtual shadow of the user for detecting a user interaction event.

### BACKGROUND OF THE INVENTION

1. Technical Field

The disclosed embodiments relate in general to user interface technology and, more specifically, to systems and methods for interacting with large displays using shadows.

2. Description of the Related Art

As would be appreciated by persons of ordinary skill in the art, gesture interaction employing depth cameras have become popular, especially for gaming applications. However, in general, gesture interaction may present certain reliability problems, especially when multiple users try to interact with the system at the same time. Systems based on the user skeleton tracking likewise suffer from reliability problems, which are exacerbated when the user stands too close or too far from the display. In other words, users of these existing systems have difficulty understanding an active distance for interacting with objects on the display. Moreover, if the user's skeleton representation is used to provide an interaction feedback to the user, such feedback is usually not intuitive and may even be overly complicated for most commonplace user interaction with the system, resulting in a compromised user experience.

Thus, as would be appreciated by those of skill in the art, in view of the aforesaid deficiencies of the conventional technology, new and improved systems and methods are needed for user interaction with large displays.

### SUMMARY OF THE INVENTION

The embodiments described herein are directed to methods and systems that substantially obviate one or more of the above and other problems associated with the conventional systems and methods for interacting with large displays.

In accordance with one aspect of the inventive concepts described herein, there is provided a computer-implemented method being performed in a computerized system incorporating a processing unit, a memory, a display and a depth camera, the computer-implemented method involving: acquiring a depth image of a user using the depth camera; determining a spatial position of a point cloud corresponding to the user using the acquired depth image of the user; determining at least a portion of the point cloud corresponding to the user located within a virtual operation area; generating a virtual shadow of the user using the determined portion of the point cloud corresponding to the user located within the virtual operation area; displaying the generated virtual shadow of the user on the display; and using the displayed virtual shadow of the user for detecting a user interaction event.

In one or more embodiments, the depth camera is configured to acquire the depth image of a user positioned in front of the display.

In one or more embodiments, the virtual operation area is an area of a predetermined depth located immediately in front of the display.

In one or more embodiments, the virtual shadow of the user is generated based on a spatial position of a virtual light source and a virtual screen surface.

In one or more embodiments, the virtual light source is a parallel light source positioned behind and over a head of the user.

In one or more embodiments, the method further comprises changing the spatial position of the virtual light source based on a spatial position of the user.

In one or more embodiments, the method further comprises changing the spatial position of the virtual light source based on a command received from the user.

In one or more embodiments, pixel values of the virtual shadow of the user are calculated based on a distance between the virtual screen surface and a point corresponding to the pixel of the virtual shadow.

In one or more embodiments, pixels of the virtual shadow corresponding to points that are closer to the virtual screen surface are assigned higher pixel intensity.

In one or more embodiments, pixels of the virtual shadow corresponding to points in the point cloud located within the virtual operation area are shown on the display using a color different from the rest of the shadow.

In one or more embodiments, the method further comprises changing a type of the virtual shadow based on a position of the user and a predetermined threshold value.

In one or more embodiments, the type of the shadow is changed if a distance between the user and the display is below the predetermined threshold value.

In one or more embodiments, the method further comprises classifying the user as being active or non-active.

In one or more embodiments, the user is classified as active if a distance between the user and the display is smaller than a predetermined threshold.

In one or more embodiments, the user is classified as non-active if a distance between the user and the display is greater than a predetermined threshold.

In one or more embodiments, the user interaction event is detected only if the user is classified as active.

In one or more embodiments, classifying the user as being active or non-active involves performing a face detection operation and wherein the user is classified as active only if the face detection indicates that the user faces the display.

In one or more embodiments, the computerized system further incorporates a second display and the method further involves generating a second virtual shadow of the user and displaying the generated second virtual shadow of the user on the second display, wherein the virtual shadow of the user is generated based on a spatial position of a virtual light source and wherein the second virtual shadow of the user is generated based on a spatial position of a second virtual light source.

In one or more embodiments, the user interaction event is detected based on overlap of at least a portion of the virtual shadow of the user with a hotspot of a graphical user interface widget.

In one or more embodiments, the hotspot of a graphical user interface widget comprises a plurality of sensor pixels and wherein the user interaction event is detected based on overlap of at least a portion of the virtual shadow of the user with at least two sensor pixels of the plurality of sensor pixels.

In one or more embodiments, the method further comprises transforming the virtual shadow of the user based on a proximity of the virtual shadow to the graphical user interface widget on the display and a type of the graphical user interface widget.

In accordance with another aspect of the inventive concepts described herein, there is provided a non-transitory computer-readable medium embodying a set of computer-executable instructions, which, when executed in a computerized system incorporating a processing unit, a memory, a display and a depth camera, cause the computerized system to perform a method involving: acquiring a depth image of a user using the depth camera; determining a spatial position of a point cloud corresponding to the user using the acquired depth image of the user; determining at least a portion of the point cloud corresponding to the user located within a virtual operation area; generating a virtual shadow of the user using the determined portion of the point cloud corresponding to the user located within the virtual operation area; displaying the generated virtual shadow of the user on the display; and using the displayed virtual shadow of the user for detecting a user interaction event.

In accordance with yet another aspect of the inventive concepts described herein, there is provided a computerized system incorporating a processing unit, a memory, a display and a depth camera, the memory storing a set of computer-executable instructions causing the computerized system to perform a method involving: acquiring a depth image of a user using the depth camera; determining a spatial position of a point cloud corresponding to the user using the acquired depth image of the user; determining at least a portion of the point cloud corresponding to the user located within a virtual operation area; generating a virtual shadow of the user using the determined portion of the point cloud corresponding to the user located within the virtual operation area; displaying the generated virtual shadow of the user on the display; and using the displayed virtual shadow of the user for detecting a user interaction event.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive concepts. Specifically:

FIG. 1 illustrates an exemplary embodiment of a system 100 for interacting with large displays using shadows.

FIG. 2 illustrates exemplary virtual screen surface and virtual operation areas.

FIG. 3 illustrates changing types of shadow based on the position of the person.

FIG. 4 illustrates an embodiment, wherein based on the position of the user, the Virtual Light Source changes dynamically.

FIG. 5 illustrates an exemplary embodiment, wherein three separate displays (Display 1, Display 2 and Display 3) are associated with three separate Virtual Light Sources.

FIG. 6(a) shows a horizontally oriented button GUI widget incorporating a hotspot with multiple sensor pixels.

FIG. 6(b) shows a vertically oriented button GUI widget incorporating a hotspot having multiple sensor pixels.

FIG. 7 illustrates transforming the shadow of the user to improve effectiveness of the person's interaction with the vertically oriented button GUI widget.

FIG. 8 illustrates an exemplary embodiment of a computerized system for interacting with large displays using shadows.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

To address the above and other problems associated with the conventional technology, one or more embodiments described herein implement systems and methods for interacting with a large display for presentation and other applications. Specific exemplary operations supported by one or more embodiments described herein may include, without limitation, changing slides, controlling a pointer, and showing feedback to the user. Specifically, one or more of the described embodiments use a silhouette or a shadow-based approach to implementing user interfaces for large displays. To this end, the described system generates user's shadow based on an appropriately located virtual light source and displays the generated shadow on the display thereby providing feedback to the user.

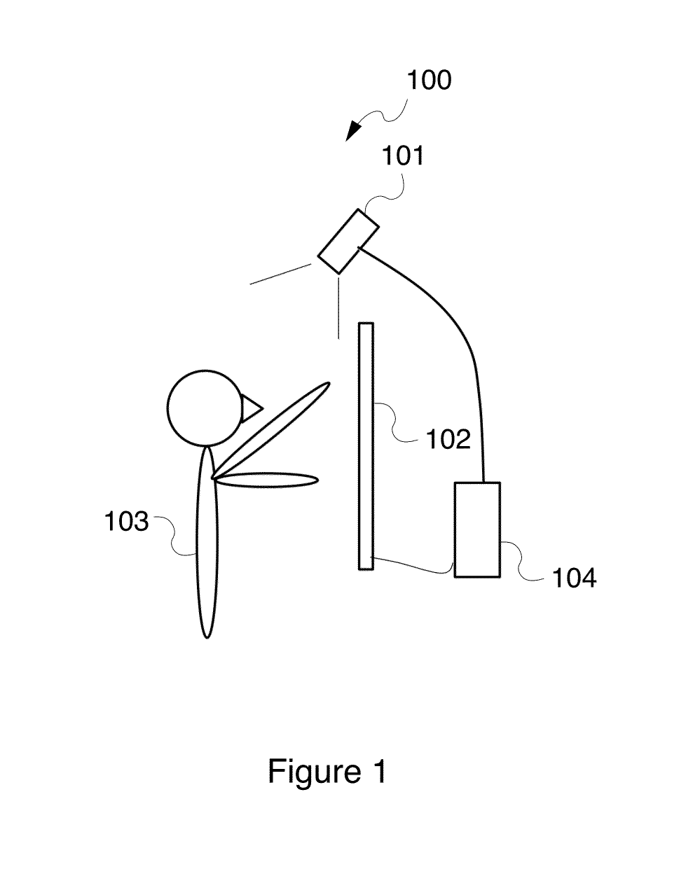

FIG. 1 illustrates an exemplary embodiment of a system 100 for interacting with large displays using shadows. In one or more embodiments, the system 100 incorporates a large display 102 configured to display a digital content to the user(s) and a depth sensor 101, which is placed on a display 102, as shown, for example in FIG. 1. In one or more embodiments, the depth sensor 101 may be a depth-imaging camera. As well known in the art, depth-imaging cameras provide conventional (sometimes color) images as well as depth information for each pixel in the acquired images (depth images). In other words, the depth sensor 101 is configured to sense the three-dimensional (3D) point cloud of a person 103 in front of the display 102. Because the spatial positions of display 102 and the depth sensor 101 are known, the global coordinates of the 3D point cloud corresponding to the person 103 can be derived from the depth image information provided by the depth sensor 101. The system 100 further includes a computer system 104 for receiving depth image information from the depth sensor 101 and for displaying the content and the generated shadows on the display 102.

### Virtual Operation Area Based on 3D Information

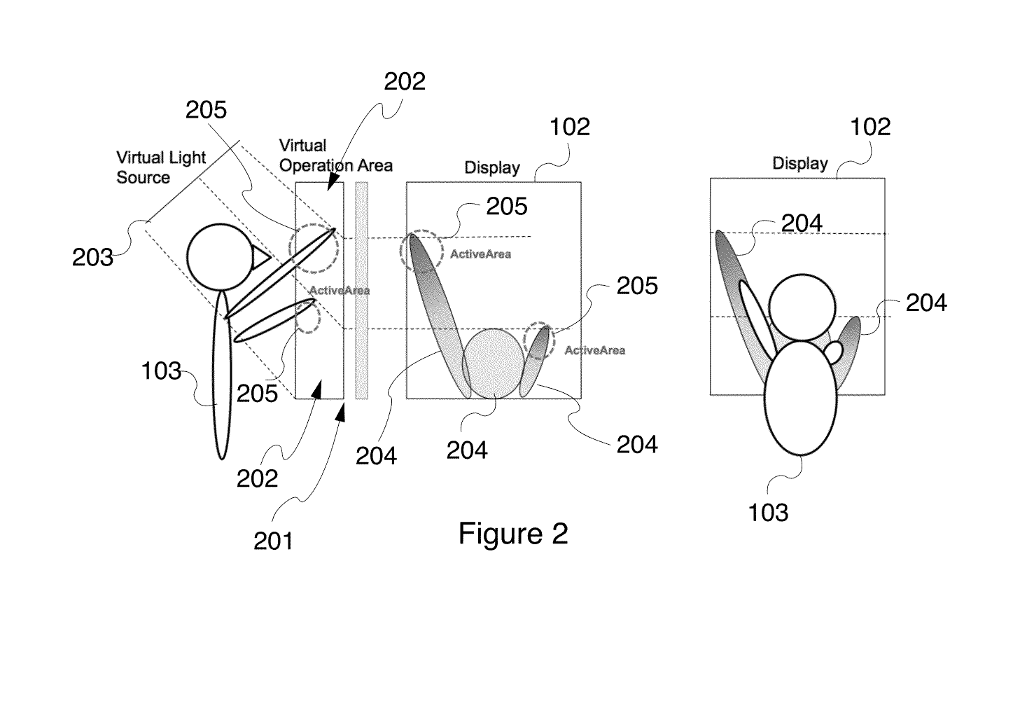

In one or more embodiments, using the aforesaid 3D information from the depth sensor 101, a Virtual Screen Surface 201 and a Virtual Operation Area 202 are defined, as illustrated, for example, in FIG. 2. In one exemplary embodiment both the Virtual Screen Surface 201 and the Virtual Operation Area 202 are located in front of the display 102, see FIG. 2. In one or more embodiments, the Virtual Operation Area 202 is an area of a predetermined depth. This depth may be determined such that it would be intuitive for the user to be located within this area during user's interaction with the display 102.

In one or more embodiments, a virtual parallel light source 203 behind and over the head of the user 103 creates the operator's shadow on the Virtual Screen Surface 201. In one embodiment, the virtual shadow image 204 is created from the aforesaid 3D point cloud corresponding to the user by a coordinate transform as illustrated in FIG. 2. Specifically, the pixel values of the virtual shadow image are calculated from the distance from Virtual Screen Surface 201 to the corresponding 3D point. In one embodiment, the points in the point cloud that are closer to the Virtual Screen Surface 201 are set to a higher pixel intensity values than ones far from the surface 201.

In one or more embodiments, parts of the point cloud that are inside the Virtual Operation Area 202 create Active Areas 205 in the virtual shadow image 204. In one embodiment, pixels of the point cloud within the Active Area 202 may be shown in different color (e.g. red color). In one or more embodiments, a user is enabled to point or operate on the display contents using the Active Areas 205.

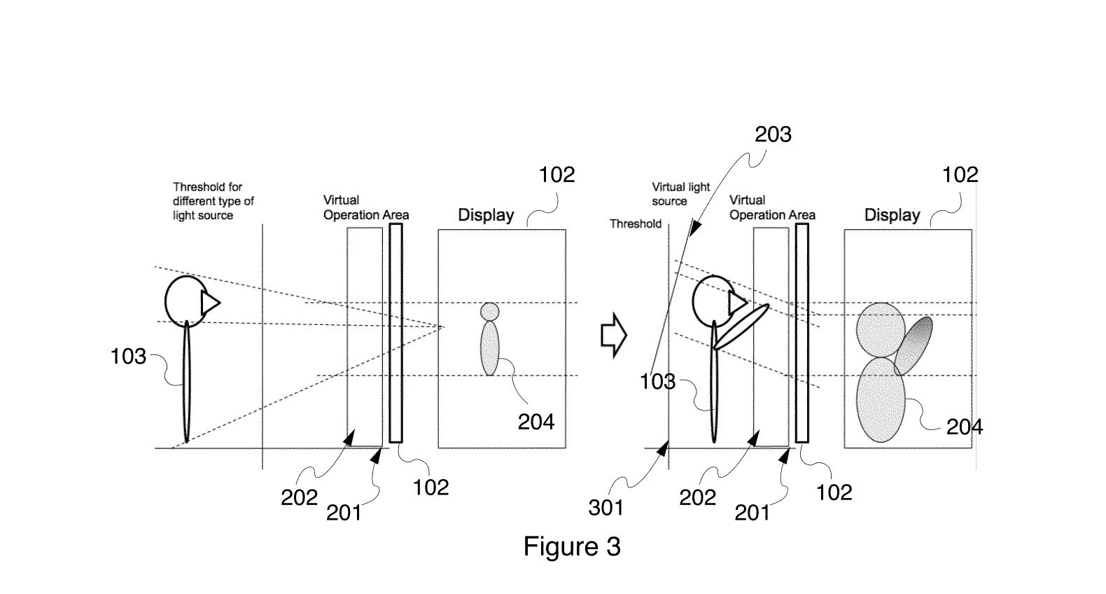

In one or more embodiments, the types of shadow 204 may be changed based on the position of the person 103 in relation to the Virtual Screen Surface 201. This can be done, for example, by changing the shadow type based on the distance of the person 103 to the Virtual Screen Surface 201 by changing the shadow appearance and using an appropriate transform. An example is shown in FIG. 3, which illustrates changing types of shadow 204 based on the position of the person 103.

With reference to FIG. 3, when the person 103 is far away from the display 102, using the 3D point cloud provided by the depth sensor 101, a silhouette of the person 103 is created by the system 100 and it is rendered as a shadow 204 on the display 102. When the person 103 notices the shadow 204, and walks to the display 102, the shadow 204 becomes progressively larger. In one embodiment, this effect is accomplished by using a perspective transform with the center of projection placed behind the Virtual Screen Surface 201. In other words, in this case, the Virtual Light Source 203 is placed behind the Virtual Screen Surface 201. In one embodiment, when the person 103 comes closer to the display 102 than a predetermined threshold 301, the shadow 204 changes to the types described above (e.g. different color renderings around the Active Areas) to allow that person to operate with the shadow image 204.

### Controlling Virtual Light Source(s), Virtual Operation Area, Virtual Screen Surface

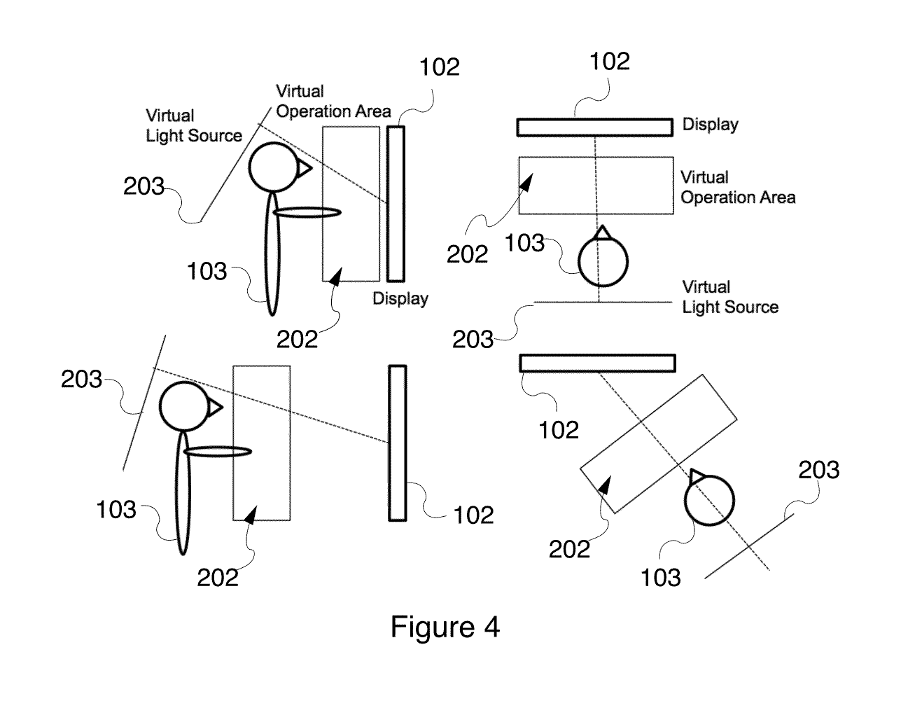

Now, novel methods for the controlling the Virtual Light Source(s) 203, Virtual Operation Area 202 and Virtual Screen Surface 201 will be described. In one embodiment, the Virtual Light Source(s) 203 are dynamically controlled by the position of the operator (user) 103. This light source 203 is moved so that the shadow of the user's arm is located in a convenient place inside the Virtual Operation Area 202 and in front of the Virtual Screen Surface 201, as illustrated in FIG. 4. Specifically, FIG. 4 illustrates an embodiment, wherein based on the position of the user 103, the Virtual Light Source 203 changes dynamically.

As would be appreciated by persons of ordinary skill in the art, the spatial position of the user 103 is determined by the 3D coordinates of the user's head, which include x and y coordinates in the floor plane as well as the z coordinate, which determines the height of the user's head above the floor level. In various embodiments, these three coordinates may be determined using a depth-imaging sensor described above, by using 3D point clouds and without the need for the skeleton tracking of the user.

In one or more embodiments, the direction of the virtual light from the virtual light source 203 may also be changed manually by the user. While the user's dominant hand (e.g. the right hand of a right handed person) is for interacting with the Virtual Operation Area 202, the non-dominant hand or other body parts may be used to control the position of the Virtual Light Source 203. For example, the non-dominant hand may be used to make gestures to move the Virtual Light Source 203 up/down or left/right. This may be useful when the person 103 has difficulty reaching the top of a display 102, or when working with a very large display 102.

### Handling Multiple Users, and Handling Multiple Displays

In one or more embodiments, for handling multiple users 103, the system 100 is configured to use the RGB color channel in addition to the depth channel of the depth-imaging camera 101. For this purpose, the depth-imaging camera 101 providing color information, in addition to the depth information, may be used.

One function that is implemented in one embodiment of the system 100 is to classify the active and inactive users 103. In one exemplary embodiment, the user classification is based on the distance between the user 103 and the display 102, wherein users 103 too far from the display 102 are classified as inactive. To this end, a predetermined distance threshold may be used for identifying inactive users. In another exemplary embodiment, machine learning techniques may be applied on the user 103 body part features. In yet another alternative embodiment, the system 100 may apply face detection, such that the users 103 not facing the display 102 are classified as inactive. As would be appreciated by persons of ordinary skill in the art, the system 100 may use any one or any suitable combination of the described techniques for identifying active and inactive users.

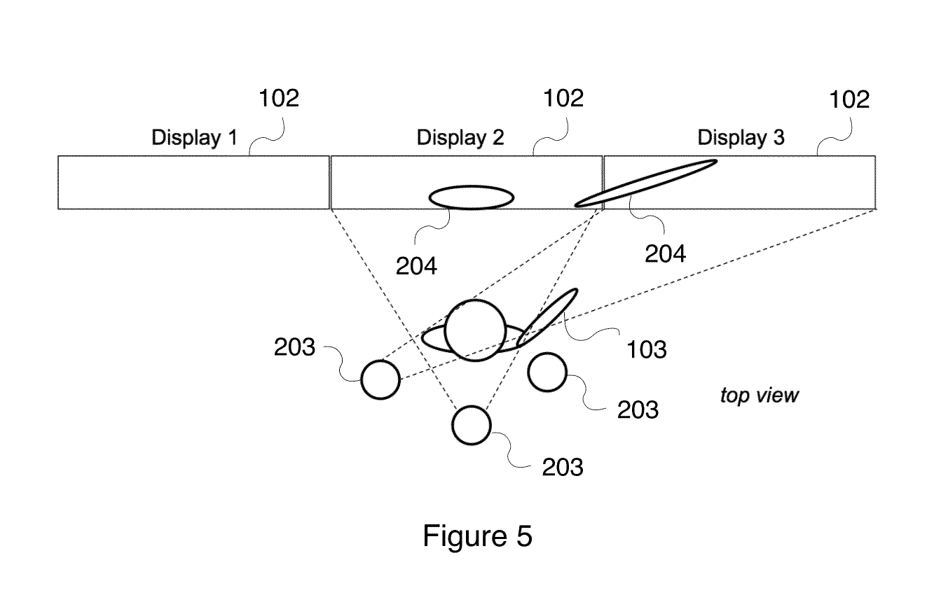

In one or more embodiments, for handling multiple displays 102, each display 102 may be associated with a separate Virtual Light Source 203. The visible area on the displays 102 with respect to the user 103 may be calculated based on the position of the user's head and body. Then the shadows 204 are created in the visible area by using the appropriate Virtual Light Source 203, as shown, for example, in FIG. 5. In this figure, three separate displays 102 (Display 1, Display 2 and Display 3) are associated with three separate Virtual Light Sources 203. Each display 102 displays a shadow 204 based on the position of the corresponding Virtual Light Source 203 and the position of the user 103 with respect to the display 102.

Interacting with Gesture-Based GUI Widgets

In one or more embodiments, the shadow 204 displayed on the display 102 may be used to interact with gesture-based graphical user interface (GUI) widgets, described, for example, in commonly owned U.S. Patent Application Publication US20140313363. Such widgets may incorporate salient hotspots that accept user gestures. For example, making a swipe gesture on a stripe-shaped hotspot of a button widget activates a button click event. As would be appreciated by persons of ordinary skill in the art, unlike invisible in-the-air gestures that are popularly used for games with a depth sensor, the aforesaid gesture-based graphical user interface widgets are more robust and provide visual cues and feedback to the user.

It would be apparent to a person of ordinary skill in the art that a generic GUI widget may be operated with the shadow-based interaction techniques described herein. For example, if the system 100 detects that the user's hand shadow displayed on the display 102 covers (e.g. overlaps with) a portion (e.g. 30%) of a button widget also displayed on the display 102 for a certain period of time (e.g. 1 second), the system 100 may be configured to generate a button click event. In various embodiments, the system 100 may use various time duration and degree of overlap thresholds for triggering such an event. However, as would be appreciated by persons of ordinary skill in the art, such user interface would not be as robust as the gesture-based graphical user interface widgets described in the aforesaid U.S. Patent Application Publication US20140313363, which are more highly constrained to reduce false widget activations.

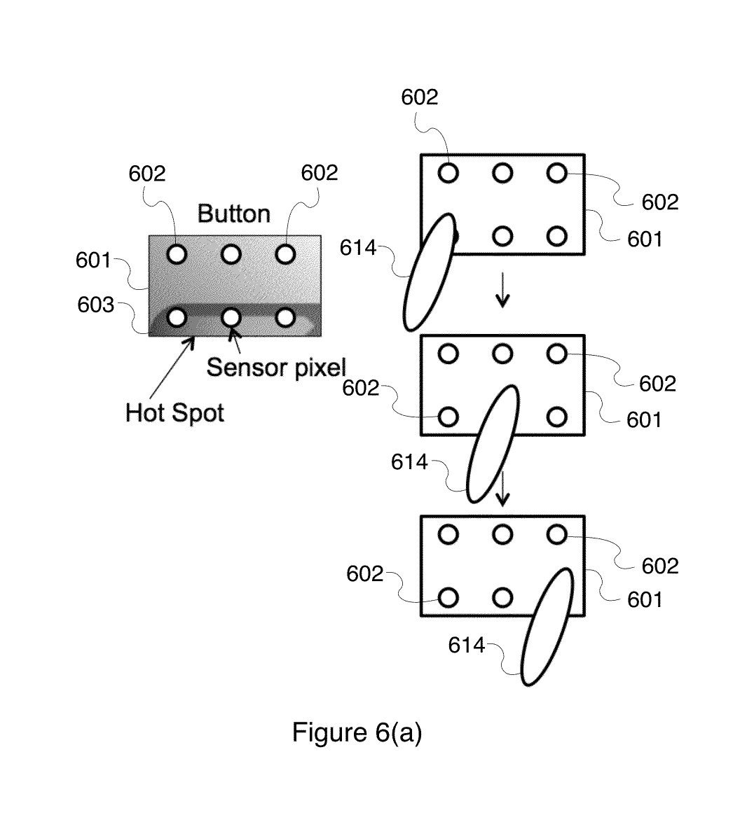

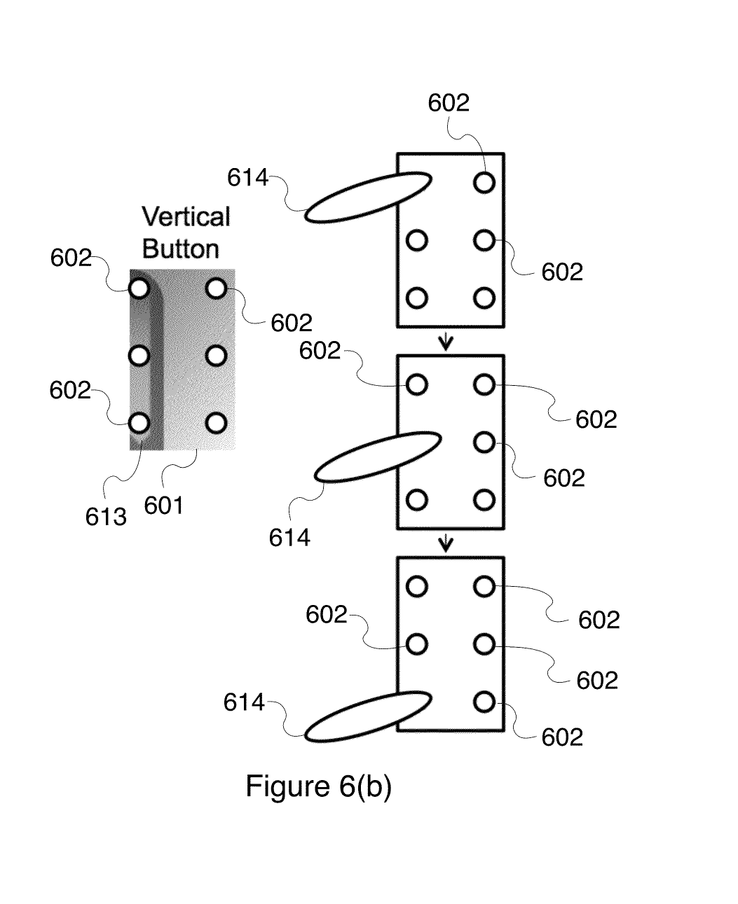

Specifically, the gesture-based graphical user interface widgets described in the aforesaid patent publication are configured to detect gestures performed by users on the hot spots incorporating multiple sensor pixels, and occlusion patterns made by the shadow are processed by a gesture recognizer. In various embodiments, the gesture-based graphical user interface widgets may be oriented horizontally or vertically, as illustrated, for example, in FIGS. 6(a) and 6(b). Specifically, FIG. 6(a) shows a horizontally oriented button GUI widget 601 incorporating a hotspot 603 with multiple sensor pixels 602. On the other hand, FIG. 6(b) shows a vertically oriented button GUI widget 611 incorporating a hotspot 613 having multiple sensor pixels 602. The aforesaid widget operates by detecting a sequential occlusion of multiple neighboring sensor pixels 602 by the user's hand shadow 614 (which is corresponding to 205 at FIG. 2) over a predetermined period of time, see FIGS. 6(a) and 6(b).

As would be appreciated by persons of ordinary skill in the art, when using the vertical widget button 611 shown in FIG. 6(b), the vertical hand shadow 614 must be turned to be substantially horizontal, so that it does not cover up all the sensor pixels 602 at the same time, see FIG. 6(b). On the other hand, this hand posture may be awkward for the user to make in the real life setting. To deal with this problem, one or more embodiments of the system 100 is configured to automatically move the Virtual Light Source 203 when the shadow approaches the vertical widget button 611, such that the user's hand shadow 614 is oriented in a substantially horizontal manner. In other words, by shifting the Virtual Light Source 203, the system 100 turns the shadow so that it will not occlude the sensor pixels in a way that interferes with the operation of the vertically oriented button GUI widget 611.

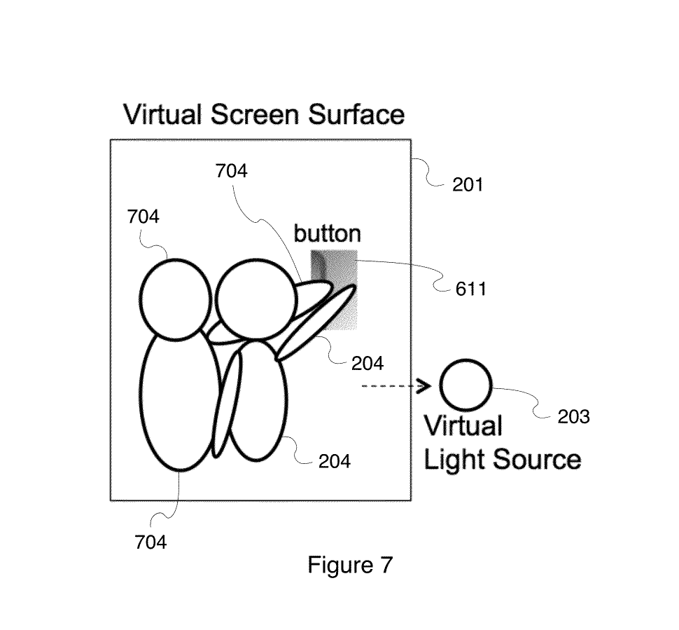

FIG. 7 illustrates transforming the shadow 204 of the user 103 to improve effectiveness of the person's interaction with the vertically oriented button GUI widget 611. Specifically, when the system 100 detects that the user's shadow 204 approaches the button 611, the system 100 is configured to reposition the virtual light source 203 in order to transform the shadow 204 into shadow 704, which reduces the interference with the widget 611. As would be appreciated by persons of ordinary skill in the art, the illustration of the repositioning of the virtual light source 203 in connection with the vertically oriented widget button is exemplary only and the system 100 may be configured to reposition the virtual light source 203 to improve effectiveness of any other type of GUI widget. Thus, the above examples should not be interpreted in a limiting sense.

### Exemplary Computer Platform

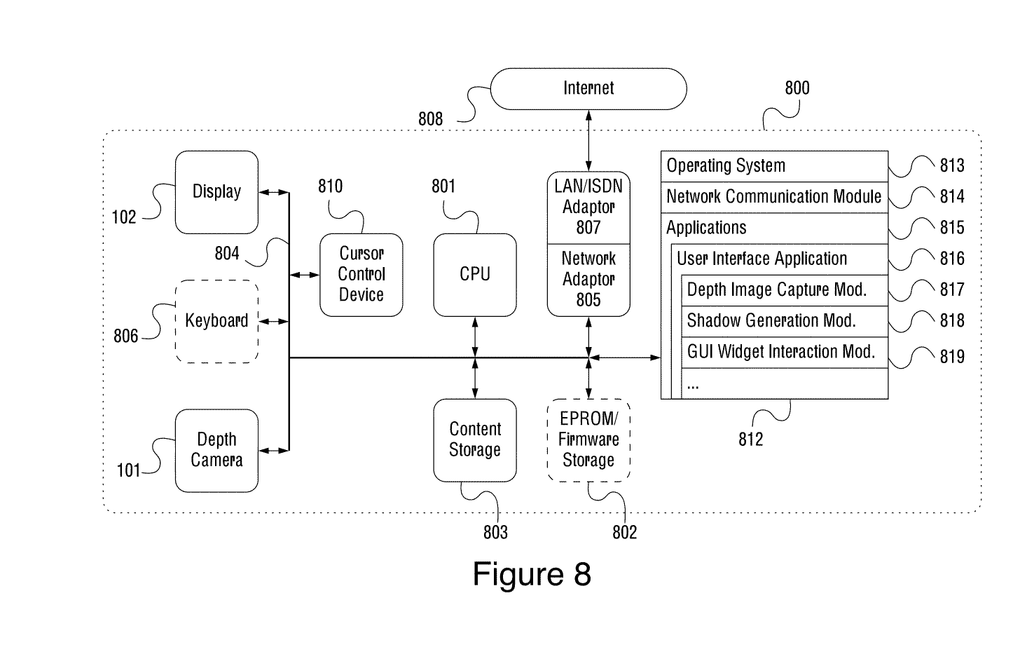

FIG. 8 illustrates an exemplary embodiment of a computerized system 800 for interacting with large displays using shadows. In one or more embodiments, the computerized system 800 may be implemented within the form factor of a desktop computer, well known to persons of skill in the art. In an alternative embodiment, the computerized system 800 may be implemented based on a laptop or a notebook computer, a tablet or a smartphone. In yet an alternative embodiment, the system 800 may be embedded into the large display itself.

The computerized system 800 may include a data bus 804 or other interconnect or communication mechanism for communicating information across and among various hardware components of the computerized system 800, and a central processing unit (CPU or simply processor) 801 electrically coupled with the data bus 804 for processing information and performing other computational and control tasks. Computerized system 800 also includes a memory 812, such as a random access memory (RAM) or other dynamic storage device, coupled to the data bus 804 for storing various information as well as instructions to be executed by the processor 801. The memory 812 may also include persistent storage devices, such as a magnetic disk, optical disk, solid-state flash memory device or other non-volatile solid-state storage devices.

In one or more embodiments, the memory 812 may also be used for storing temporary variables or other intermediate information during execution of instructions by the processor 801. Optionally, computerized system 800 may further include a read only memory (ROM or EPROM) 802 or other static storage device coupled to the data bus 804 for storing static information and instructions for the processor 801, such as firmware necessary for the operation of the computerized system 800, basic input-output system (BIOS), as well as various configuration parameters of the computerized system 800.

In one or more embodiments, the computerized system 800 may incorporate the large display device 102, also shown in FIG. 1, which may be also electrically coupled to the data bus 804, for displaying various content as well as the shadows generated in accordance with the techniques describe above. In an alternative embodiment, the display device 102 may be associated with a graphics controller and/or graphics processor (not shown). The display device 102 may be implemented as a liquid crystal display (LCD), manufactured, for example, using a thin-film transistor (TFT) technology or an organic light emitting diode (OLED) technology, both of which are well known to persons of ordinary skill in the art. In various embodiments, the display device 102 may be incorporated into the same general enclosure with the remaining components of the computerized system 800. In an alternative embodiment, the display device 102 may be positioned outside of such enclosure, such as on the floor or a wall. Also provided may be content storage 803 for storing various content for displaying on the display 102. The content storage 803 is also communicatively coupled to the data bus 804.

In one or more embodiments, the computerized system 800 may incorporate one or more input devices, including cursor control devices, such as a mouse/pointing device 810, such as a mouse, a trackball, a touchpad, or cursor direction keys for communicating direction information and command selections to the processor 801 and for controlling cursor movement on the display 102. This input device typically has two degrees of freedom in two axes, a first axis (e.g., x) and a second axis (e.g., y), that allows the device to specify positions in a plane.

The computerized system 800 may further incorporate the depth imaging camera 101 for acquiring depth images of the user 103 as described above, as well as a keyboard 806, which all may be coupled to the data bus 804 for communicating information, including, without limitation, images and video, as well as user commands (including gestures) to the processor 801.

In one or more embodiments, the computerized system 800 may additionally include a communication interface, such as a network adaptor 805 coupled to the data bus 804. The network adaptor 805 may be configured to establish a connection between the computerized system 800 and the Internet 808 using at least a local area network (LAN) and/or ISDN adaptor 807. The network adaptor 805 may be configured to enable a two-way data communication between the computerized system 800 and the Internet 808. The LAN adaptor 807 of the computerized system 800 may be implemented, for example, using an integrated services digital network (ISDN) card or a modem to provide a data communication connection to a corresponding type of telephone line, which is interfaced with the Internet 808 using Internet service provider's hardware (not shown). As another example, the LAN adaptor 807 may be a local area network interface card (LAN NIC) to provide a data communication connection to a compatible LAN and the Internet 808. In an exemplary implementation, the LAN adaptor 807 sends and receives electrical or electromagnetic signals that carry digital data streams representing various types of information.

In one or more embodiments, the Internet 808 typically provides data communication through one or more sub-networks to other network resources, which may be implemented using systems similar to the computerized system 800. Thus, the computerized system 800 is capable of accessing a variety of network resources located anywhere on the Internet 808, such as remote media servers, web servers, other content servers as well as other network data storage resources. In one or more embodiments, the computerized system 800 is configured to send and receive messages, media and other data, including application program code, through a variety of network(s) including the Internet 808 by means of the network interface 805. In the Internet example, when the computerized system 800 acts as a network client, it may request code or data for an application program executing on the computerized system 800. Similarly, it may send various data or computer code to other network resources.

In one or more embodiments, the functionality described herein is implemented by computerized system 800 in response to processor 801 executing one or more sequences of one or more instructions contained in the memory 812. Such instructions may be read into the memory 812 from another computer-readable medium. Execution of the sequences of instructions contained in the memory 812 causes the processor 801 to perform the various process steps described herein. In alternative embodiments, hard-wired circuitry may be used in place of or in combination with software instructions to implement the embodiments of the invention. Thus, the described embodiments of the invention are not limited to any specific combination of hardware circuitry and/or software.

The term “computer-readable medium” as used herein refers to any medium that participates in providing instructions to the processor 801 for execution. The computer-readable medium is just one example of a machine-readable medium, which may carry instructions for implementing any of the methods and/or techniques described herein. Such a medium may take many forms, including but not limited to, non-volatile media and volatile media.

Common forms of non-transitory computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read. Various forms of computer readable media may be involved in carrying one or more sequences of one or more instructions to the processor 801 for execution. For example, the instructions may initially be carried on a magnetic disk from a remote computer. Alternatively, a remote computer can load the instructions into its dynamic memory and send the instructions over the Internet 808. Specifically, the computer instructions may be downloaded into the memory 812 of the computerized system 800 from the foresaid remote computer via the Internet 808 using a variety of network data communication protocols well known in the art.

In one or more embodiments, the memory 812 of the computerized system 800 may store any of the following software programs, applications or modules:

1. Operating system (OS) 813 for implementing basic system services and managing various hardware components of the computerized system 800. Exemplary embodiments of the operating system 813 are well known to persons of skill in the art, and may include any now known or later developed mobile operating systems.

2. Network communication module 814 may incorporate, for example, one or more network protocol stacks, which are used to establish a networking connection between the computerized system 800 and the various network entities of the Internet 808, using the network adaptor 805.

3. Applications 815 may include, for example, a set of software applications executed by the processor 801 of the computerized system 800, which cause the computerized system 800 to perform certain predetermined functions, such as acquire depth images of the user using the depth camera 102, as well as generating the shadows using the techniques described above. In one or more embodiments, the applications 815 may include the inventive user interface application 816 incorporating the functionality described above.

In one or more embodiments, the inventive user interface application 816 incorporates a depth image capture module 817 for capturing depth images of the user 103 using the depth camera 101. In addition, inventive user interface application 816 may incorporate a shadow generation module 818 for performing shadow generation in accordance with the techniques described above. Further provided may be GUI widget interaction module for generating gesture-based graphical user interface widgets and detecting user interaction therewith using the shadows. In various embodiments, appropriate user interface events may be generated by the user interface application 816 based on the detected user interaction.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, Objective-C, perl, shell, PHP, Java, as well as any now known or later developed programming or scripting language.

Moreover, other implementations of the invention will be apparent to those skilled in the art from consideration of the specification and practice of the invention disclosed herein. Various aspects and/or components of the described embodiments may be used singly or in any combination in the systems and methods for interacting with large displays using shadows. It is intended that the specification and examples be considered as exemplary only, with a true scope and spirit of the invention being indicated by the following claims.

What is claimed is:

1. A computer-implemented method being performed in a computerized system comprising a processing unit, a memory, a display and a depth camera, the computer-implemented method comprising:
a. acquiring a depth image of a user using the depth camera;
b. determining a spatial position of a point cloud corresponding to the user using the acquired depth image of the user;
c. determining at least a portion of the point cloud corresponding to the user located within a virtual operation area;
d. generating a virtual shadow of the user using the determined portion of the point cloud corresponding to the user located within the virtual operation area;
e. displaying the generated virtual shadow of the user on the display; and
f. using the displayed virtual shadow of the user for detecting a user interaction event.

2. The computer-implemented method of claim 1, wherein the depth camera is configured to acquire the depth image of a user positioned in front of the display.

3. The computer-implemented method of claim 1, wherein the virtual operation area is an area of a predetermined depth located immediately in front of the display.

4. The computer-implemented method of claim 1, wherein the virtual shadow of the user is generated based on a spatial position of a virtual light source and a virtual screen surface.

5. The computer-implemented method of claim 4, wherein the virtual light source is a parallel light source positioned behind and over a head of the user.

6. The computer-implemented method of claim 4, further comprising changing the spatial position of the virtual light source based on a spatial position of the user.

7. The computer-implemented method of claim 4, further comprising changing the spatial position of the virtual light source based on a command received from the user.

8. The computer-implemented method of claim 4, wherein pixel values of the virtual shadow of the user are calculated based on a distance between the virtual screen surface and a point corresponding to the pixel of the virtual shadow.

9. The computer-implemented method of claim 8, wherein pixels of the virtual shadow corresponding to points that are closer to the virtual screen surface are assigned higher pixel intensity.

10. The computer-implemented method of claim 1, wherein pixels of the virtual shadow corresponding to points in the point cloud located within the virtual operation area are shown on the display using a color different from the rest of the shadow.

11. The computer-implemented method of claim 1, further comprising changing a type of the virtual shadow based on a position of the user and a predetermined threshold value.

12. The computer-implemented method of claim 11, wherein the type of the shadow is changed if a distance between the user and the display is below the predetermined threshold value.

13. The computer-implemented method of claim 1, further comprising classifying the user as being active or non-active.

14. The computer-implemented method of claim 13, wherein the user is classified as active if a distance between the user and the display is smaller than a predetermined threshold.

15. The computer-implemented method of claim 13, wherein the user is classified as non-active if a distance between the user and the display is greater than a predetermined threshold.

16. The computer-implemented method of claim 13, wherein in f. the user interaction event is detected only if the user is classified as active.

17. The computer-implemented method of claim 13, wherein classifying the user as being active or non-active comprises performing a face detection operation and wherein the user is classified as active only if the face detection indicates that the user faces the display.

18. The computer-implemented method of claim 13, wherein the computerized system further comprising a second display, the method further comprising generating a second virtual shadow of the user and displaying the generated second virtual shadow of the user on the second display, wherein the virtual shadow of the user is generated based on a spatial position of a virtual light source and wherein the second virtual shadow of the user is generated based on a spatial position of a second virtual light source.

19. The computer-implemented method of claim 1, wherein in f. the user interaction event is detected based on overlap of at least a portion of the virtual shadow of the user with a hotspot of a graphical user interface widget.

20. The computer-implemented method of claim 19, wherein the hotspot of a graphical user interface widget comprises a plurality of sensor pixels and wherein the user interaction event is detected based on overlap of at least a portion of the virtual shadow of the user with at least two sensor pixels of the plurality of sensor pixels.

21. The computer-implemented method of claim 19, further comprising transforming the virtual shadow of the user based on a proximity of the virtual shadow to the graphical user interface widget on the display and a type of the graphical user interface widget.

22. A non-transitory computer-readable medium embodying a set of computer-executable instructions, which, when executed in a computerized system comprising a processing unit, a memory, a display and a depth camera, cause the computerized system to perform a method comprising:
a. acquiring a depth image of a user using the depth camera;
b. determining a spatial position of a point cloud corresponding to the user using the acquired depth image of the user;
c. determining at least a portion of the point cloud corresponding to the user located within a virtual operation area;
d. generating a virtual shadow of the user using the determined portion of the point cloud corresponding to the user located within the virtual operation area;
e. displaying the generated virtual shadow of the user on the display; and
f. using the displayed virtual shadow of the user for detecting a user interaction event.

23. A computerized system comprising a processing unit, a memory, a display and a depth camera, the memory storing a set of computer-executable instructions causing the computerized system to perform a method comprising:
a. acquiring a depth image of a user using the depth camera;
b. determining a spatial position of a point cloud corresponding to the user using the acquired depth image of the user;
c. determining at least a portion of the point cloud corresponding to the user located within a virtual operation area;
d. generating a virtual shadow of the user using the determined portion of the point cloud corresponding to the user located within the virtual operation area;
e. displaying the generated virtual shadow of the user on the display; and
f. using the displayed virtual shadow of the user for detecting a user interaction event.
